(19) United States
(12) Patent Application Publication
(10) Pub. No.: US 2009/0159628 A1
(43) Pub. Date: Jun. 25, 2009

(54) Pet carrier

(76) Inventor: Joseph Edwad McMullen, Greenville, SC (US)

Correspondence Address: Alan A. Csontos, 6 Triple Crown Court, Greenville, SC, 29615, US

(21) Appl. No.: 12/004,699

(22) Filed: Dec. 21, 2007

(51) Int. Cl. A01K 29/00

(52) U.S. Cl. 224/576; 2/69

(57) ABSTRACT

The pet carrier is a garment which has a pouch positioned on the upper torso of a person. The pouch is formed between an inner layer and an outer layer which are attached to each other at about mid-torso and near each shoulder of the person. The pouch has at least one side open so a pet can be placed therein. The garment has supports, attached to the top of the inner or outer layer, which extend over the shoulders and down the front or the back of the person to at least the mid-torso, where they are attached to the inner or outer layer at the sides. The inner or outer layer or a separate piece and the supports can further extend downward to about the waist of the person. The garment can have the appearance of a poncho, a vest, a shirt or a sweater which is suitable for wearing without a pet in the pouch.

### FIELD OF THE INVENTION

The present invention is in the field of apparel, and the invention relates to a garment worn by a person to carry small pets.

### BACKGROUND OF THE INVENTION

Many people have small pets such as cats, small dogs, rabbits, guinea pigs, ferrets, etc., which they would like to take with them on walks, bicycling, boating, and other activities. However, due to their size and other factors, small pets are difficult to be taken places or walked on a leash. Hence, various pet carriers have been devised to carry a small pet.

Even though this invention is a pet carrier, designs for baby carriers are noted. Hence, in this background, designs for both baby carriers and pet carriers are disclosed; it being understood that this invention is directed to pet carriers.

Three general types of devices are used as baby or pet carriers.

Harness Types. Many infant carrier designs feature a separate item of apparel which is worn over the shoulder and around the neck of the person with the infant secured in a harness with the baby's legs, arms and head protruding out U.S. Pat. Nos. 4,434,920; 4,402,440; 5,791,535; 5,813,580; and 6,672,493 show the harness types. Other harness type carriers are for pets, and the design features a cage or garment attached to the harness. U.S. Pat. Nos. 5,044,321; 5,176,102; 5,277,148; and 6,701,871 and Design Pats. D370, 090; D334, 253 and D383, 305 show these harness types for pets.

Sling Types. Some patents show “sling” type carriers, in which a garment is worn over the shoulder(s) of the person and the baby placed in a holder which is worn on the side of the person. U.S. Pat. Nos. 4,166,558; 6,343,727; 6,435,185; and 6,595,396 show these sling types.

Coat Types. Some patents show a type of coat which covers the baby or pet while it is being carried. In U.S. Pat. No. 4,079,467, the baby is placed in a sling type carrier with a coat worn over the baby and person. The coat has a pocket for the baby's posterior to rest in. In U.S. Pat. No. 4,606,078, the baby is carried in a harness type apparatus, but a vest can be worn by the person against his/her body on the inside and a coat is worn on the outside of the person. The baby is in a carrier between the vest and the coat. U.S. Pat. No. 5,946,725 describes a garment worn by the person which allows the baby to be in contact with the skin of the person for comfort and nurture reasons (called Kangarooing). The garment has a pouch on its inside which holds the baby and covers it from the outside. Design Pat. D539, 509 shows a garment where a pet is placed in a large front pocket, open at the top and located at the waist of the person.

### SUMMARY OF THE INVENTION

The pet carrier of the Invention is a garment having a pouch which, when worn by a person, is positioned on the upper torso in front or in back of the person. The pouch is formed between an inner layer which extends downward from about shoulder height to about mid-torso of the person, and an outer layer which extends downward from about shoulder height to about mid-torso of the person, at which mid-torso point the two layers are attached to each other. The inner layer and outer layer are also attached to each other at least at points near each shoulder. The inner and outer layers extend sideways to about the shoulders. The pouch has at least one side open. The pet is placed in the pouch. The garment has supports attached to the top of the inner layer or outer layer, which supports extend over the shoulders and down to at least about mid-torso, where the supports are attached to the inner layer or outer layer.

The inner layer or outer layer of the garment, or both, or a separate piece attached to the inner layer or outer layer or both, can extend further downward in front or in back to about the waist of a person. The supports go over the shoulders and around the neck and can extend downward to about the waist of the person. The inner layer or outer layer or separate piece and supports are attached at the sides.

The materials of construction of the garment and designs on the garment can be anything appropriate for use in a large variety of climate conditions or activities.

### BRIEF DESCRIPTION OF THE FIGURES

FIG. 1A shows the right-side front of a pet carrier comprised basically of the pouch and the supports. The pouch is located in front at a position between the shoulders and down to about the mid-torso of a person.

FIG. 1B shows the right-side back of a basic pet carrier where the supports extend over the shoulders, around the neck and down the back of a person to about mid-torso. The supports are attached to the outer layer in front at about mid-torso of a person.

FIG. 1C shows the right-sided back of a basic pet carrier where the supports are attached to straps which extend around to the front where the straps are attached at about mid-torso of a person. The straps are attached to themselves in the back.

FIG. 1D shows a layout of a garment which can form a basic pet carrier. The inner layer and outer layer and supports are part of a continuous piece.

FIG. 2 shows the right-side front of a pet carrier which has the appearance of a poncho. The pouch is located in front at a position between the shoulders and mid-torso of a person. The outer layer is a separate piece which is attached to the inner layer. The inner layer extends downward in front to about the waist of a person. The supports extend to about the waist of a person where the inner layer and the support are attached by straps.

FIG. 3A shows the right-sided front of a pet carrier which has the appearance of a vest. The pouch is formed between the outer layer and the inner layer, which is a separate piece attached to the outer layer. The outer layer extends downward in front to about the waist of a person. The supports are continuous with the outer layer, and extend in back in a single piece to about the waist of a person. The outer layer has openings at both sides and at the top of the pouch.

FIG. 3B shows the right-sided front of a pet carrier which has the appearance of a vest. Here the pouch is formed between the inner layer and the outer layer, which is a separate piece attached to the inner layer. The inner layer extends downward in front to about the waist of a person. The supports are continuous with the inner layer, and extend in back in a single piece to about the waist of a person.

FIG. 3C shows the right-sided front of a pet carrier which also has the appearance of a vest. Here the pouch is larger at the top. The outer layer is a separate piece which is attached to the inner layer, and both the inner layer and the outer layer both extend down to about the waist of a person. The supports are continuous with the inner layer, and extend in back in a single piece to about the waist of a person. The outer layer has openings on the sides near the waist of a person.

FIG. 4 shows the right-sided front of a pet carrier which has the appearance of a shirt. The supports, which are continuous with the inner layer, have a sleeve attached at each shoulder which extends down the arm of a person to about the elbow. The pet carrier has an inner layer extending downward in front to about the waist of a person and an outer layer, which is a separate piece which also extends downward in front to about the waist of a person. The outer layer has openings on the sides near the waist of a person.

FIG. 5 shows the right-sided front of a pet carrier which has the appearance of a sweater. The supports, which are continuous with the inner layer, have a sleeve attached at each shoulder which extends down the arm of a person to about the wrists.

FIG. 6 shows a view of a person wearing a sweater-type pet carrier with a small dog in the pouch. The outer layer and inner layer both extend downward to about the waist of a person. The inner layer is a separate piece attached to the outer layer. The outer layer has pockets on each side near the waist.

### DETAILED DESCRIPTION OF THE INVENTION

In the invention, the pet is placed in a pet carrier which is worn by a person and which comprises a garment having a pouch located at a position between the shoulders and mid-torso of the person. In this location, the pouch provides greater safety and security for the pet because the pet is less prone to being bumped by the person or by another object or person. Further, the close proximity of the pet in the pouch to the heart of the person provides comfort and intimacy to the pet which can hear or feel the heartbeat of the person. At least one side of the pouch is open so the pet can be readily placed in the pouch. The top of the pouch can be open near its middle so the pet can stick out its head and see.

The pet carrier can be worn as a garment with or without the pet placed inside of the pouch, and yet maintain the appearance of a traditional article of apparel. This feature enhances the utility of the pet carrier because it does not require the person wearing the garment to carry additional items and/or change for different social settings.

Although the garment is normally worn so that the pouch is in front, the garment can be worn with the pouch in the back. With the pouch in front, the supports, when the garment is worn by a person, go over the shoulders and down the back of the person to at least the mid-torso and then attach to the inner layer or outer layer. With the pouch in back, the supports go over the shoulders, around the neck and continue down the front in a single piece to at least the mid-torso of the person and then attach to the inner layer or outer layer.

The pouch, in all of the embodiments and design variations, can be open at one of its sides, open at both of its sides and/or open at its top. At least one side is open to facilitate the person to place the pet in the pouch. The open sides of the pouch and the opening at the top can be closed once the pet is placed inside the pouch. Hence, each opening can have a zipper, hooks, hook and loop fasteners, snaps, buttons and the like at the opening which can be used to close the opening once the pet is placed inside the pouch.

In the invention, the phrase “attached” means that the items described are secured to each other by virtue of how it is manufactured, or by sewing or tying, or by use of hooks, buttons, snaps, garment snaps, zippers, hook and loop fasteners and the like.

In one embodiment of the invention, the pet carrier comprises basically the pouch and the supports. The pouch is located at a position which, when the garment is worn by a person, is between the shoulders and the mid-torso of the person. The pouch is formed by an inner layer which extends from about the shoulders of the person downward to about the mid-torso of the person, and an outer layer which extends from about the shoulders to about the mid-torso of the person. The inner layer and outer layer are attached to each other at positions near the shoulders and at about mid-torso. The pouch so formed has an opening on at least one side and can have an opening at the top of the pouch near its middle. The garment has supports which attach in front or in back, depending on how the garment is worn, to the inner layer or outer layer or both, and which extend over the shoulders and downward, where the supports are attached to the inner layer or the outer layer or both at the sides.

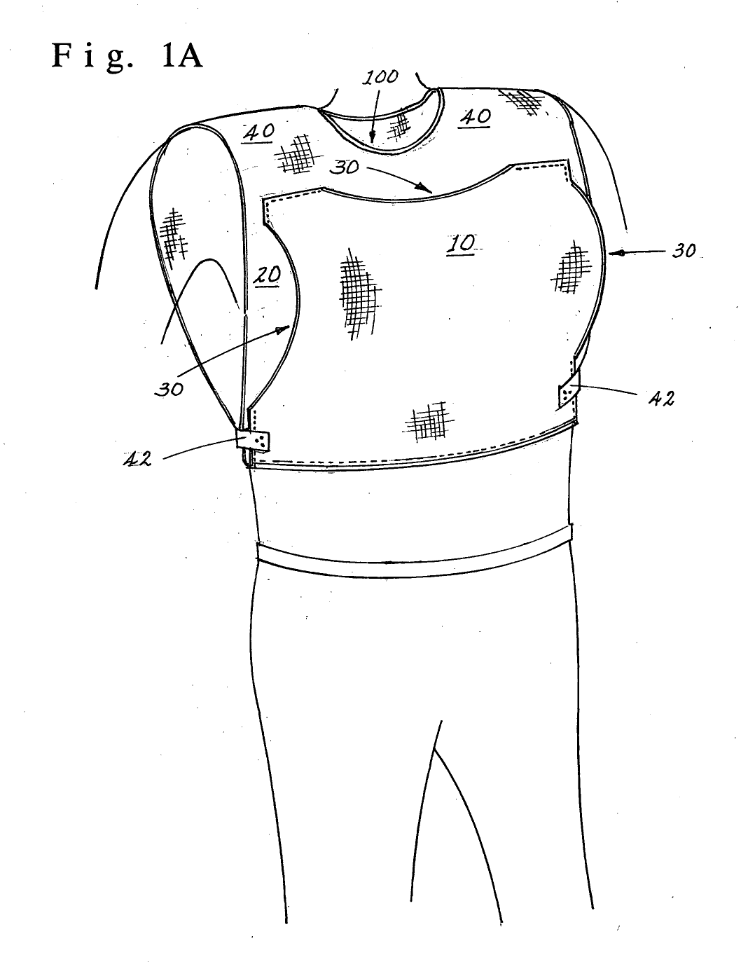

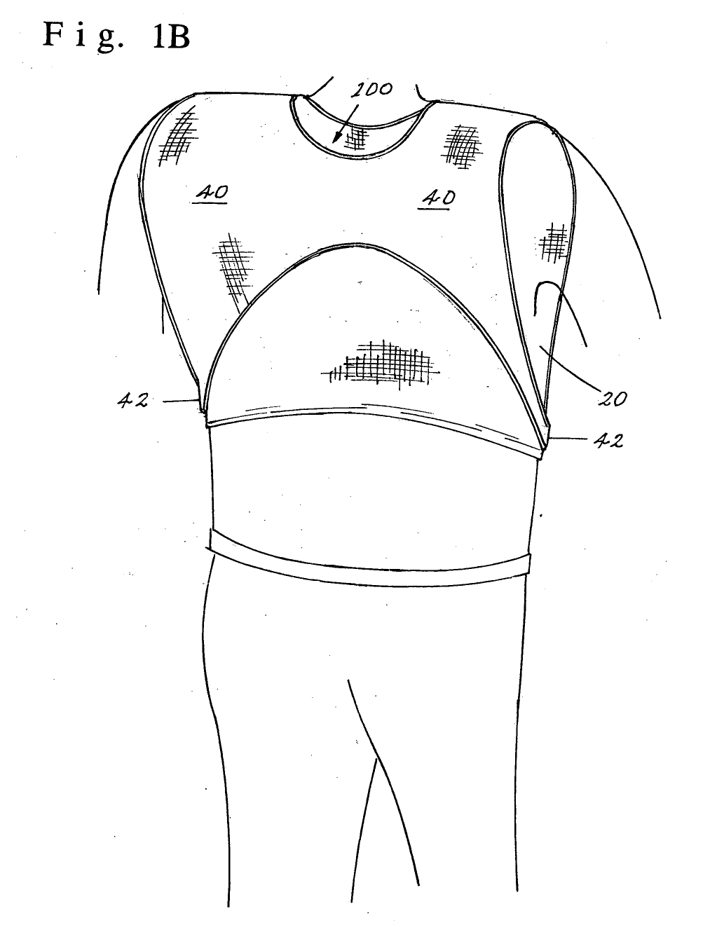

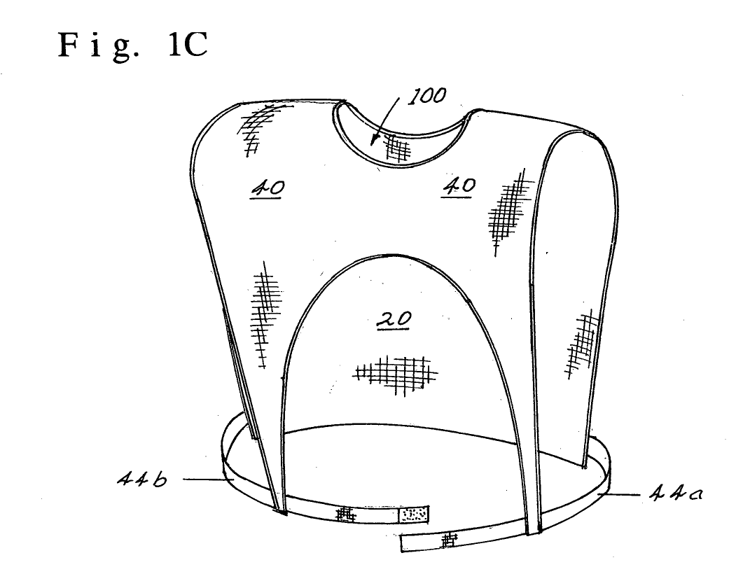

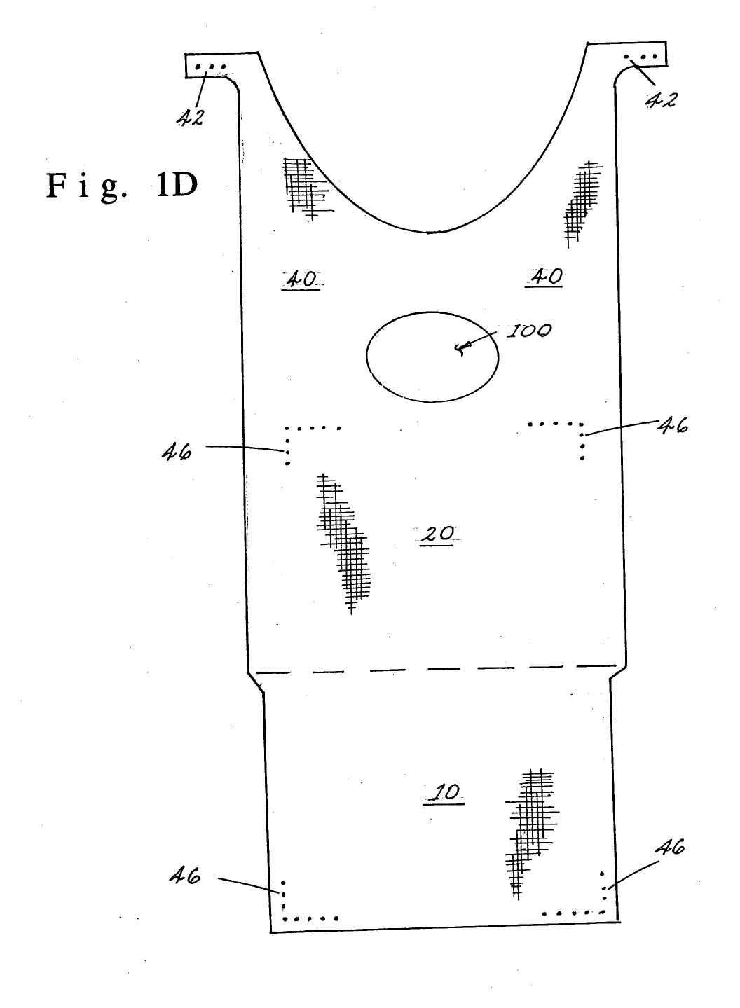

FIG. 1A depicts the right-sided frontal view of the basic embodiment where the pouch is in front. In FIG. 1A, the pet carrier is comprised basically of the pouch and the supports. The pouch is located in front at a position which, when worn by a person, is between the shoulders and about the mid-torso of the person. The outer layer (10) is a separate piece attached to the inner layer (20) at about mid-torso and at a point near each shoulder of the person. The supports (40) are attached to the inner layer and extend over the shoulders and down the back of the person. The pouch is open at each side (30), and open at the top near the middle (30). The garment has an opening for the head (100) of the person. The supports in back are attached by tabs (42) to the outer layer in front.

In the basic embodiment, the supports can be attached to the inner layer or outer layer in various ways. FIG. 1B shows the right-sided back of a basic pet carrier similar to that shown in FIG. 1A. The Figure shows the supports (40) attached to the inner layer (20), and the supports extend over the shoulders, around the neck and down the back of the person. The supports are attached in front by tabs (42) to the inner layer or the outer layer at points near the mid-torso of the person.

FIG. 1C shows another design variation for the supports. In FIG. 1C, the supports (40) extend over the shoulders, around the neck and down the back of the person. The supports are attached to straps (44a and 44b) which extend around to the front where the straps are attached to the inner layer or the outer layer at about mid-torso. The straps are attached to themselves in the back.

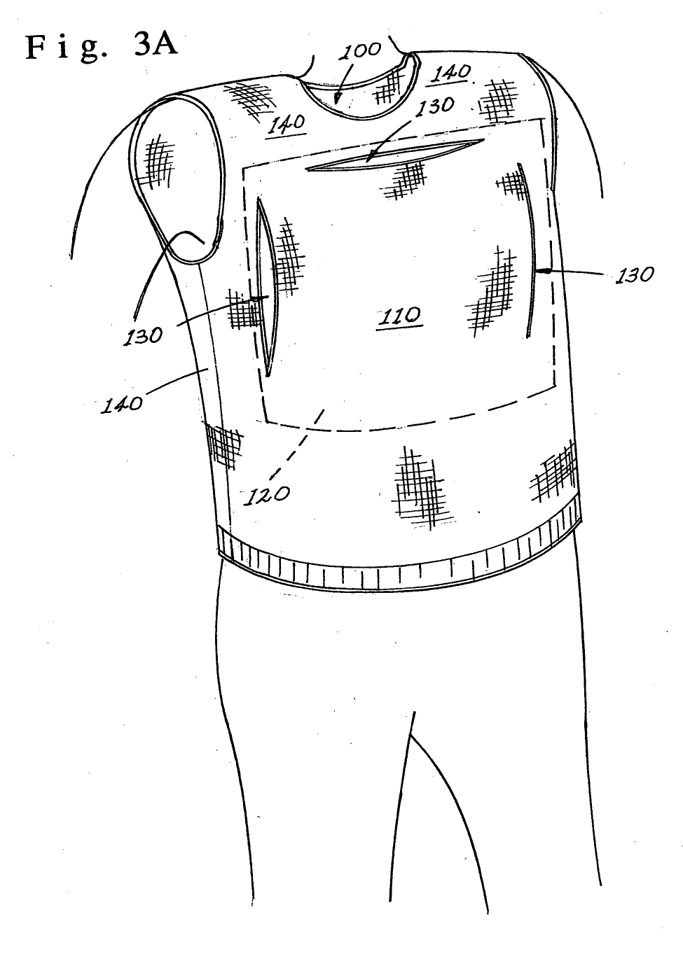

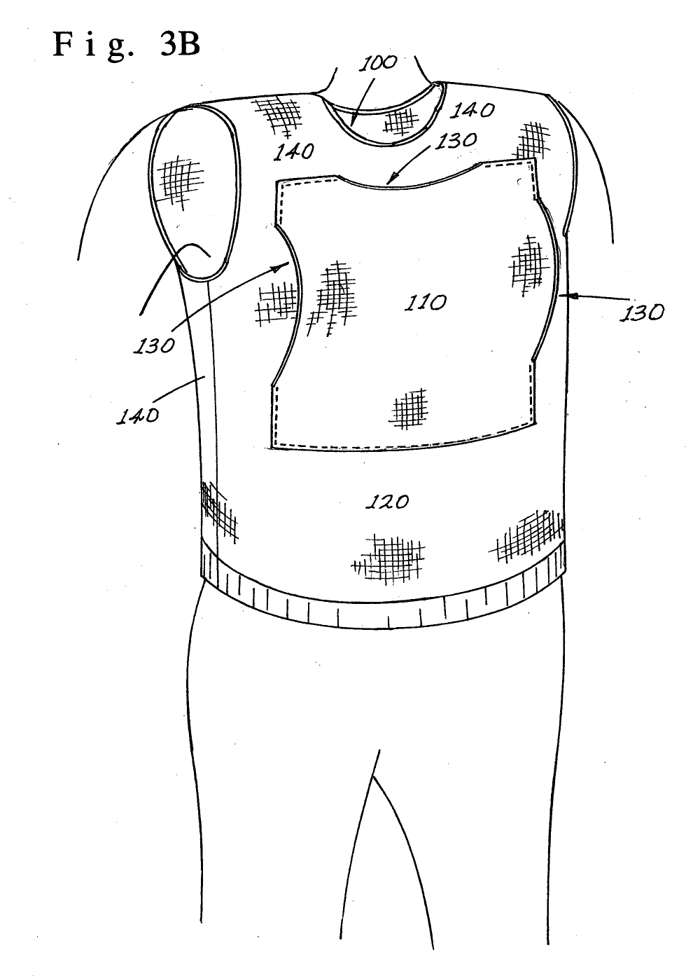

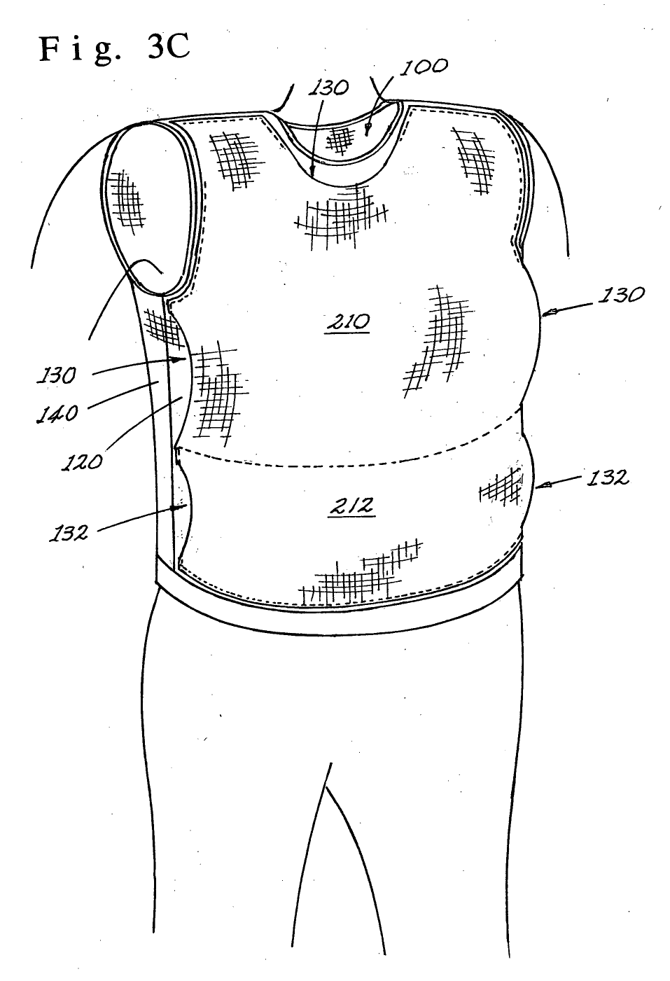

In FIGS. 1A, 1B and 1C shown above, the supports are shown in front as manufactured with the inner layer. However, the supports can also be manufactured with the outer layer if the pouch is formed as illustrated in FIG. 3A. Whether the pouch is in front or in back, the supports essentially cover the shoulders of a person. This provides the most comfort to the person wearing the garment.

As can be seen in FIGS. 1A, 1B and 1C, the pet carrier described in this first embodiment is comprised basically of the pouch and the supports. This embodiment can be readily manufactured. For example, the inner layer and outer layer and the supports can be one piece. The bottom of the piece can be rolled up on itself so that its lowest point, when the garment is worn by a person, would be at about the mid-torso of the person. The rolled up end is attached to itself at a point near each shoulder of the person. Hence, the rolled-up section forms an outer layer or an inner layer, depending on whether the piece in rolled inward or outward. The pouch is formed between the inner layer and the outer layer, and is located between the shoulders and mid-torso of a person. The inner layer and outer layer extend sideways from about shoulder to shoulder of the person. The garment has supports which are continuous with the inner layer and outer layer, and the supports extend over the shoulders, around the neck and downward where the supports are attached to the inner layer or the outer layer or both.

FIG. 1D shows a garment described as above and made of one continuous piece. Here, the bottom section of the piece is rolled-up outward so that its lowest point is located, when the garment is worn by a person, at about mid-torso of the person. The bottom of the piece is then connected to itself near each shoulder of the person by snaps (46). The pouch is formed between the inner layer (20) and the outer layer (10), and the pouch is positioned between the shoulders and mid-torso. The garment has an opening for the head (100) of the person. When worn, the garment is placed over the person's head and the supports (40) are attached by tabs (42) to the outer layer at the sides. Of course, the attachments at (46) and at (42) can any form of attachments such as snaps, buttons, hooks, hook and loop fasteners or straps.

Although FIGS. 1A, 1B, 1C and 1D are shown with the pouch in front, the described garments can be worn with the pouch in back. In this case, the supports go over the shoulders, around the neck and down the front in a single piece to about mid-torso of the person and then the supports attach to the inner layer or outer layer or both at the sides.

In another embodiment of the invention, the pet carrier has the appearance of a poncho. As in the first embodiment, the pet carrier has a pouch in front or in back, depending on how the garment is worn, located at a position which, when the garment is worn by a person, is between the shoulders and the mid-torso of the person. However, in this embodiment, the inner layer or outer layer extends further downward to about the waist of a person. The supports of the garment go over the shoulders and then around the neck and down in a single piece to about the waist of the person, where the supports and the inner layer or outer layer are attached at the sides.

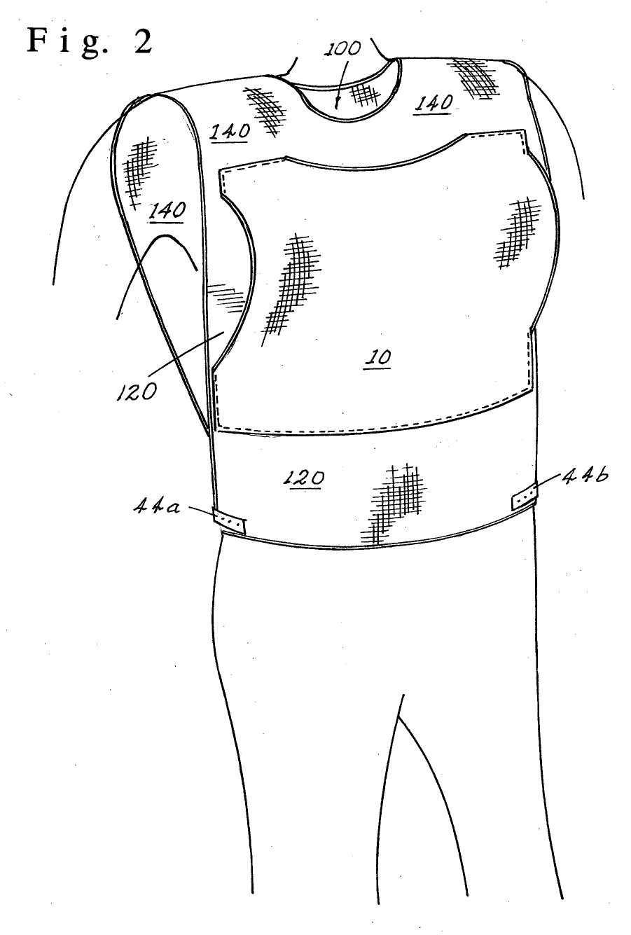

FIG. 2 shows the right-side front of a pet carrier which has the appearance of a poncho. The pouch is located in front at a position which, when the garment is worn by a person, is between the shoulders and mid-torso of the person. The outer layer (10) is a separate piece which is attached to the inner layer (120) at a point near each shoulder and at about mid-torso of a person. The inner layer extends downward in front to about the waist of the person. The supports (140) are attached to the inner layer, and, when the garment is worn by a person, the supports extend over the shoulders, around the neck and down the back of the person in a single piece to about the waist of the person. The inner layer and the supports are attached at the sides by straps (44a and 44b).

Again, the garment's pouch can be worn in front or in back. When the pouch is in back, the supports are attached to the inner layer or outer layer in back, go over the shoulders, around the neck and then continue downward in front to about the waist of the person where the supports are attached to the inner layer or outer layer at the sides.

In yet another embodiment of the invention, the pet carrier has the appearance of a vest. The pet carrier has a pouch formed between an outer layer and an inner layer where one layer is a piece of material separate from the other layer. In one case, the inner layer is a separate piece which is attached to the outer layer at a point which, when the garment is worn by a person, is near the shoulders and at about the mid-torso of the person. The outer layer extends downwards in front to about the waist of a person. The supports, when the garment is worn by a person, go over the shoulders and then around the neck and down the back in a single piece to about the waist of the person. The outer layer and the supports are attached at the sides. The outer layer in front has openings at the sides and top of the pouch. The outer layer in front can also have pockets at each side which are positioned near the waist of a person so that he/she can place his/her hands or other objects in the pockets.

FIG. 3A shows a vest type pet carrier with the pouch in front where the inner layer (120) is a separate piece attached to the outer layer (110) at positions which, when the garment is worn by a person, are at about the mid-torso and near the shoulders of the person. The outer layer extends downward in front to about the waist of the person. The supports (140) are attached with the outer layer, and, when the garment is worn by a person, the supports go over the shoulders, and then around the neck and down the back of the person in a single piece to about the waist of the person. The outer layer and supports are attached at the sides. The outer layer has openings (130) at the sides of the pouch and at the top of the pouch to permit the pet to be placed inside the pouch and see out.

In a variation of the vest type embodiment described above, the garment's pouch is formed between an inner layer and an outer layer where the outer layer is a separate piece. The outer layer is attached to the inner layer at points which, when the garment is worn by a person, are near each shoulder and at about the mid-torso of the person. The inner layer extends in front from about shoulder height to about the waist of the person. The carrier has supports which are attached with the inner layer, and, when the garment is worn by a person, the supports go over the shoulders and then around the neck and down the back of the person in a single piece. At least one side of the pouch is open, and the pouch can be open at the top near its middle. The inner layer is attached to the supports at the sides. In this variation, the front of the inner layer can have pockets on the sides which are positioned at about the waist of a person.

FIG. 3B shows the right-sided front of a pet carrier similar to that illustrated in FIG. 3A, but here the pouch is formed in front between an inner layer (120) and an outer layer (110) which is a separate piece attached to the inner layer at positions which, when the garment is worn by a person, are near the shoulders and at about the mid-torso of the person. The inner layer (120) extends downward in front to about the waist of a person. The supports (140) are attached with the inner layer, and, when the garment is worn by a person, the supports go over the shoulder, and then around the neck and down the back of the person in a single piece to about the waist of the person. The inner layer and supports in back are attached at the sides. The pouch has openings (130) at each side and at the top near its middle.

FIG. 3C shows yet another variation of the vest type pet carrier. Here the pouch is formed in front between an outer layer and an inner layer both of which have a similar shape and size. This variation can enhance the look of the pet carrier. The inner layer and the outer layer both extend downward so that, when the garment is worn by a person, both layers extend to about the waist the person. In FIG. 3C, the outer layer (210) is a separate piece attached to the inner layer (120) at positions which, when the garment is worn by a person, are at the top of the shoulders, at about mid-torso and at about the waist of the person. The pouch has openings (130) at the sides and at the top. The supports (140) are attached with the inner layer, and, when the garment is worn by a person, the supports go over the shoulders, and then around the neck and down the back of the person in a single piece. The inner layer and supports are attached at the sides. The outer layer in front (212) below the pouch has openings (132) at positions near the waist of a person.

Again, although FIGS. 3A, 3B, and 3C show the vest type garment with the pouch in front, these garments can be worn with the pouch in back. In this case, the supports go over the shoulders, and then around the neck and extend downward in front in a single piece to about the waist of the person, where the supports are attached to the inner layer or outer layer at the sides. With the pouch in back, there is no need for openings in back in the outer layer or pockets in back the inner layer.

In the above embodiments and variations, instead of the inner layer or outer layer or both extending downward from about the mid-torso to about the waist of the person, there can be a separate piece of material which attaches to the inner layer or outer layer or both at about the mid-torso and then extends down to about the waist.

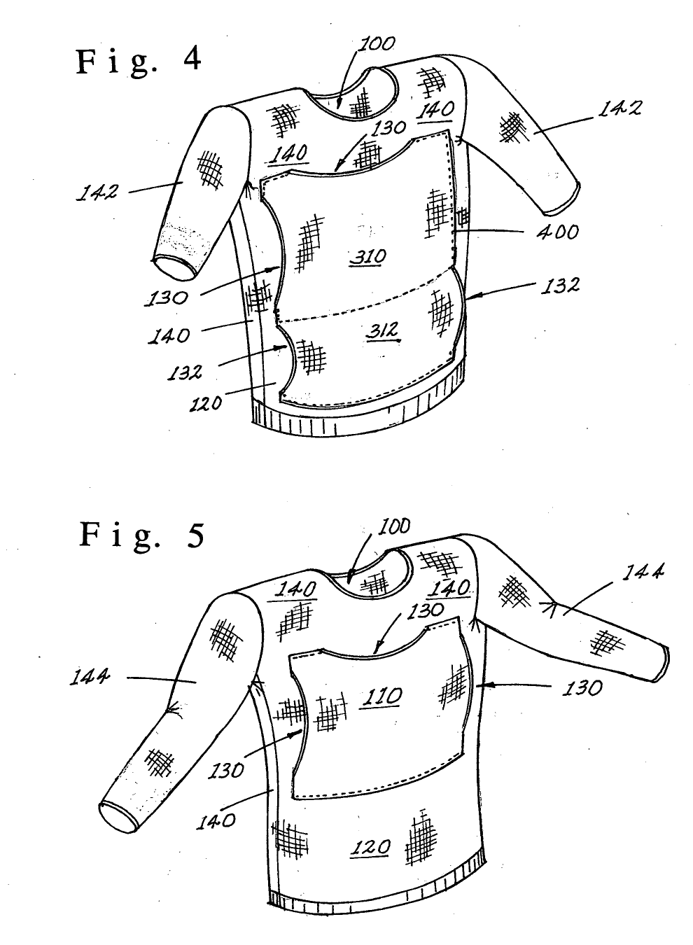

In yet another embodiment of the invention, the pet carrier has the appearance of a shirt. In this embodiment, the garment has sleeves which are attached to the supports at each shoulder and which extend down the arms to at least the elbows. FIG. 4 shows the right-sided front of a pet carrier which has the appearance of a shirt. The pet carrier, when the garment is worn by a person, has an inner layer (120) extending downward in front from near the shoulders to about the waist of the person and the supports (140), which are attached to the inner layer, extend over the shoulders, around the neck and then downward in back in a single piece to about the waist of the person. The inner layer and supports are attached at the sides. The outer layer (310) extends downward in front from near the shoulders to about the waist of the person. The outer layer is attached to the inner layer at points which, when the garment is worn by a person, are near each shoulder, at about mid-torso and at about the waist the person. The pouch formed by the outer layer (310) has an opening (130) on the right side and at the top of the pouch. The left side of the pouch is closed by an attachment (400). The outer layer (312) in front below the pouch has openings (132) on each side near the waist of a person so the person can place his/her hands or other objects inside. The sleeves (142) are attached to the supports at the shoulders. The attachment (400) is such that the opening can be closed after the pet is placed in the pouch.

Again, the shirt type pet carrier can be worn with the pouch in back. In this case, the supports go over the shoulders, and then around the neck and extend downward in front in a single piece to about the waist of the person, where the supports are attached to the inner layer or outer layer at the sides. With the pouch in back, there is no need for openings in back in the outer layer or pockets in back the inner layer.

In yet another embodiment of the invention, the pet carrier has the appearance of a sweater. The pet carrier is similar to the shirt type pet carrier illustrated in FIG. 4; but, here the sleeves extend down the arms to at least the wrists. FIG. 5 illustrates this embodiment. In FIG. 5, the outer layer (110) is attached to the inner layer (120) at points which, when the garment is worn by a person, are near each shoulder and at about the mid-torso of the person. The supports (140) are attached to the inner layer, and, when the garment is worn by a person, the supports go over the shoulders, and then around the neck and down the back in a single piece to about the waist of the person. The inner layer (120) extends down to about the waist of a person. The inner layer and supports are attached at the sides. The sleeves (144) are attached to the supports at the shoulders.

As with the shirt type embodiment, the sweater type pet carrier can be worn with the pouch in back. In this case, the supports go over the shoulders, and then around the neck and extend downward in front in a single piece to about the waist of the person, where the supports are attached to the inner layer or outer layer at the sides. With the pouch in back, there is no need for openings in back in the outer layer or pockets in back the inner layer.

In the above embodiments and variations, instead of the inner layer or outer layer or both extending downward from about the mid-torso to about the waist of the person, there can be a separate piece of material which attaches to the inner layer or outer layer or both at about the mid-torso and then extends down to about the waist.

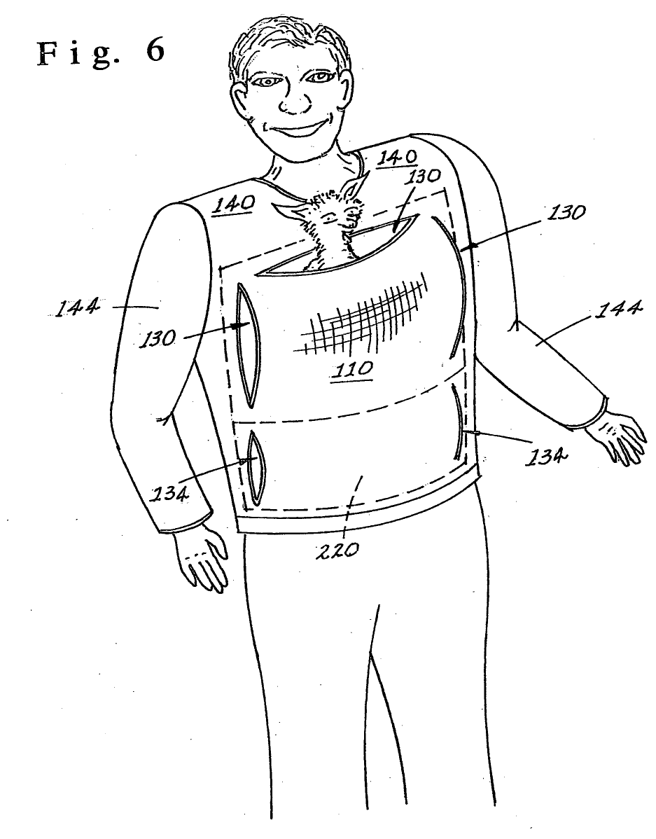

FIG. 6 shows a view of a person wearing a sweater type pet carrier with the pouch in front and a small dog in the pouch. The garment has an inner layer (220) which is a separate piece of material which, when worn by a person, extends downward in front from near the shoulders to about the waist of the person. The inner layer is attached to an outer layer (110) near the shoulders, at about the mid-torso and at about the waist of the person. The supports (140) are attached to the outer layer, and go over the shoulders, and then around the neck and down the back in a single piece to about the waist of the person. The outer layer and the supports are attached at the sides. The outer layer has openings (130) at the sides and at the top of the pouch. The outer layer also has pockets (134) at each side near the waist so the person can place his/her hands or other objects inside.

The materials of construction used for the layers, the supports, the straps and other items of the pet carrier can be any appropriate material. Typically, the materials are the same materials used to make garments worn by persons or pets. The materials can be natural materials such as cotton, wool, leather and the like, or synthetic materials such as nylon, polyester, Kevlar and the like, or the items can be made out of mixtures of natural and synthetic materials. In a given pet carrier, the materials for the layers, the supports, the straps and other items can be the same or different. The materials can be made into fabrics which can be reinforced, especially in the area of the pouch. The fabrics can be chosen to make a pet carrier for light summer wear, or for heavier winter wear, or for use in any season. For comfort, the inner layer can be made of a softer, more breathable fabric or weave, and the outer layer can be made of a fabric having good water or dirt repellency. The pouch area can have a liner on the inside of the pouch which is made of a material that protects against the claws of the pet, and can have a liner made of a material that permits easier cleaning of the garment in case of accidents.

The pet carrier can have any kind of design on it. Pet owners often like to personalize items for their pets. Hence, designs can range from favorite colors and patterns, to pictures of types of pet, to scenes, to photographs of the pets and the like.

The embodiments, Figures and variations described herein are illustrative of the invention, and are not intended to limit the designs of the pet carrier.

1. A pet carrier comprising a garment having a pouch formed between an inner layer which extends downward, when the garment is worn by a person, from near the shoulders to about the mid-torso of the person, and an outer layer which extends downward, when the garment is worn by a person, from near the shoulders to about the mid-torso of the person, where the inner layer and outer layer are attached to each other at about the mid-torso and at a point on at least each shoulder of the person, where at least one side of the pouch is open; and supports attached to the top of either one of the inner layer or outer layer, which supports, when the garment is worn by a person, go over the shoulders and downward to about mid-torso, where the supports are attached to either one of the inner layer or outer layer.

2. A carrier of claim 1, wherein the pouch is located in front and the supports go over the shoulders and down the back where they are attached to either one of the inner layer or outer layer.

3. A carrier claim 1, wherein the pouch is located in back and the supports go over the shoulders, around the neck and down the front in a single piece where they are attached to either one of the inner layer or outer layer.

4. A carrier of claim 1, wherein the inner layer, the outer layer and the supports are one piece.

5. A carrier of claim 1, wherein the pouch is located in front and the pouch has an inner layer which extends further downward in front to about the waist of the person; the supports go over the shoulder, around the neck and extend downwards in back in a single piece to about the waist of the person; and the supports are attached to the inner layer at the sides.

6. A carrier of claim 1, wherein the pouch is located in front and the pouch has an outer layer which extends further downward in front to about the waist of the person; the supports go over the shoulder, around the neck and extend downwards in back in a single piece to about the waist of the person; and the supports are attached to the outer layer at the sides.

7. A carrier of claim 1, wherein the pouch is located in back and the pouch has an inner layer which extends further downward in back to about the waist of the person; the supports go over the shoulder, around the neck and extend downwards in front in a single piece to about the waist of the person; and the supports are attached to the inner layer at the sides.

8. A pet carrier comprising a garment having a pouch formed between an inner layer which extends downward, when the garment is worn by a person, from near the shoulders to about the mid-torso of the person, and an outer layer which extends downward, when the garment is worn by a person, from near the shoulders to about the mid-torso of the person, where the inner layer and outer layer are attached at points on at least each shoulder and at about the mid-torso of the person, where at least one side of the pouch is open; having supports which are attached to either one of the inner layer or outer layer, and which supports, when the garment is worn by a person, go over the shoulders, around the neck and extend downwards in a single piece to about the waist of the person; and wherein either one of the inner layer or the outer layer or a separate piece attached to the inner layer or the outer layer or both at about mid-torso, extends further downward to about the waist of the person and the supports are attached to either one of the inner layer or outer layer or separate piece at the sides.

9. A pet carrier of claim 8, wherein the pouch is in front and the pouch has an inner layer extending downward in front from positions, when the garment is worn by a person, near the shoulders to about the waist of the person, and the outer layer is a separate piece which extends downward in front from positions, when the garment is worn by a person, near the shoulders to about the mid-torso of the person, where the inner layer and outer layer are attached to each other at a point on each shoulder and at about the mid-torso of the person, where at least one side of the pouch is open; having supports which are attached to the inner layer, and which supports, when the garment is worn by a person, go over the shoulders, around the neck and extend downwards in back in a single piece to about the waist of the person; and wherein the inner layer and the supports are attached to each other at the sides.

10. A pet carrier of claim 8, wherein the pouch is in back and the pouch has an inner layer extending downward in back from positions, when the garment is worn by a person, near the shoulders to about the waist of the person, and the outer layer is a separate piece which extends downward in back from positions, when the garment is worn by a person, near the shoulders to about the mid-torso of the person, where the inner layer and outer layer are attached to each other at a point on each shoulder and at about the mid-torso of the person, where at least one side of the pouch is open; having supports which are attached to the inner layer, and which supports, when the garment is worn by a person, go over the shoulders, around the neck and extend downwards in front in a single piece to about the waist of the person; and wherein the inner layer and the supports are attached to each other at the sides.

11. A pet carrier of claim 8, wherein the pouch is in front and the pouch has an outer layer which extends downward in front from positions, when the garment is worn by a person, near the shoulders to about the waist of the person, and the inner layer is a separate piece which extends downward in front from positions, when the garment is worn by a person, near the shoulders to about the mid-torso of the person, where the inner layer and outer layer are attached to each other near the shoulders and at about the mid-torso of the person, where at least one side of the pouch is open; having supports which are continuous with the outer layer, and which supports, when the garment is worn by a person, go over the shoulders, around the neck and extend downwards in back in a single piece to about the waist of the person; and wherein the outer layer and the supports are attached to each other at the sides.

12. A carrier of claim 8, wherein the pouch is in front and the pouch is formed between an inner layer which extends downward in front from positions, when the garment is worn by a person, at the top of the shoulders to about the mid-torso of the person, and an outer layer which extends downward in front from positions, when the garment is worn by a person, at the top of the shoulders to about the mid-torso of the person, where the inner layer and outer layer are attached at the top of each shoulder and at about the mid-torso of the person, where both the inner layer and the outer layer extend further downward to about the waist of the person, where at least one side of the pouch is open; the supports are attached to the inner layer, and which supports, when the garment is worn by a person, go over the shoulders, around the neck and extend downwards in back in a single piece to about the waist of the person, where the inner layer or the outer layer and the supports are attached to each other at the sides; and wherein the outer layer in front has openings at each side near the waist of the person.

13. A carrier of claim 8, wherein the pouch is in back and the pouch is formed between an inner layer which extends downward in back from positions, when the garment is worn by a person, at the top of the shoulders to about the mid-torso of the person, and an outer layer which extends downward in front from positions, when the garment is worn by a person, at the top of the shoulders to about the mid-torso of the person, where the inner layer and outer layer are attached at the top of each shoulder and at about the mid-torso of the person, where the inner layer extends further downward to about the waist of the person, where at least one side of the pouch is open; the supports are attached to the inner layer, and which supports, when the garment is worn by a person, go over the shoulders, around the neck and extend downwards in front in a single piece to about the waist of the person, where the inner layer and the supports are attached to each other at the sides.

14. A pet carrier comprising a garment having a pouch formed between an inner layer which extends downward from positions, when the garment is worn by a person, near the shoulders to about the mid-torso of the person, and an outer layer which extends downward from positions, when the garment is worn by a person, near the shoulders to about the mid-torso of the person, where the inner layer and outer layer are attached to each other at about the mid-torso and at a point on at least each shoulder of the person, where at least one side of the pouch is open; having supports which are attached to either one of the inner layer or outer layer, and which supports, when the garment is worn by a person, go over the shoulders, around the neck and extend downwards in a single piece to about the waist of the person; wherein either one of the inner layer or the outer layer or a separate piece which is attached to the inner layer or outer layer or both at about mid-torso, extends further downward to about the waist of the person; wherein either one of the inner layer or the outer layer or the separate piece and the supports are attached at the sides; and a sleeve is attached to the supports at each shoulder and the sleeve extends down each arm to about the wrist.

15. A pet carrier of claim 14, wherein the pouch is in front and the pouch has an inner layer which extends downward in front from positions, when the garment is worn by a person, near the shoulders to about the waist of the person, and the outer layer is a separate piece which extends downward in front from positions, when the garment is worn by a person, near the shoulders to about the mid-torso of the person, where the inner layer and outer layer are attached to each other at points on at least each shoulder and at about the mid-torso of the person, where at least one side of the pouch is open; having supports which are attached to the inner layer, and which supports, when the garment is worn by a person, go over the shoulders, around the neck and extend downwards in back in a single piece to about the waist of the person; wherein the inner layer and the supports are attached to each other at the sides.

16. A pet carrier of claim 14, wherein the pouch is in front and the pouch has an outer layer extends downward in front from positions, when the garment is worn by a person, near the shoulders to about the waist of the person, and the inner layer is a separate piece which extends downward in front from positions, when the garment is worn by a person, near the shoulders to about the mid-torso of the person, where the inner layer and outer layer are attached to each other near the shoulders and at about the mid-torso of the person, where at least one side of the pouch is open; having supports which are attached to the outer layer, and which supports, when the garment is worn by a person, go over the shoulders, around the neck and extend downwards in back in a single piece to about the waist of the person; wherein the outer layer and the supports are attached to each other at the sides.

17. A pet carrier of claim 16, wherein the inner layer extends further downward in front to about the waist of the person where it is attached to the outer layer, and the outer layer has an opening in front at each side near the waist of the person.

18. A pet carrier of claim 14, wherein the pouch is in back and the pouch has an inner layer which extends downward in back from positions, when the garment is worn by a person, near the shoulders to about the waist of the person, and the outer layer is a separate piece which extends downward in back from positions, when the garment is worn by a person, near the shoulders to about the mid-torso of the person, where the inner layer and outer layer are attached to each other at points on at least each shoulder and at about the mid-torso of the person, where at least one side of the pouch is open; having supports which are attached to the inner layer, and which supports, when the garment is worn by a person, go over the shoulders, around the neck and extend downwards in front in a single piece to about the waist of the person; wherein the inner layer and the supports are attached to each other at the sides.

19. A carrier of claim 14, wherein the sleeve extends down each arm of the person to about the elbow.

20. A carrier of claim 15, wherein the sleeve extends down each arm of the person to about the elbow.

21. A poncho suitable for holding a small pet in a pouch which is located in the upper half of the poncho, said pouch comprising an inner layer and an outer layer which are attached to each other at about the middle of the poncho and near the top of the poncho, with the inner layer and the outer layer extending sideways to near each side of the poncho, and wherein the pouch has an opening on at least one side.

22. A poncho of claim 21, wherein the pouch has an opening at the top of the pouch near the center.

23. A vest suitable for holding a small pet in a pouch which is located in the upper half of the vest, said pouch comprising an inner layer and an outer layer which are attached to each other at about the middle of the vest and near the top of the vest, with the inner layer and the outer layer extending sideways to near each side of the vest, and wherein the pouch has an opening on at least one side.

24. A vest of claim 23, wherein the pouch has an opening at the top of the pouch near the center.

25. A shirt suitable for holding a small pet in a pouch which is located in the upper half of the shirt, said pouch comprising an inner layer and an outer layer which are attached to each other at about the middle of the shirt and near the top of the shirt, with the inner layer and the outer layer extending sideways to near each side of the shirt, and wherein the pouch has an opening on at least one side.

26. A shirt of claim 25, wherein the pouch has an opening at the top of the pouch near the center

27. A sweater suitable for holding a small pet in a pouch which is located in the upper half of the sweater, said pouch comprising an inner layer and an outer layer which are attached to each other at about the middle of the sweater and near the top of the sweater, with the inner layer and the outer layer extending sideways to near each side of the sweater, and wherein the pouch has an opening on at least one side.

28. A sweater of claim 27, wherein the pouch has an opening at the top of the pouch near the center
